(19) United States
(12) Patent Application Publication
(10) Pub. No.: US 2006/0200367 A1
(43) Pub. Date: Sep. 7, 2006

(54) Anesthesia clinical calculator

(76) Inventor: Anthony Young, Lakeside, MT (US)

Correspondence Address: Burkhart & Burkhart;Patent Attorneys, 940 Dakota Avenue, Whitefish, MT, 59937, US

(21) Appl. No.: 11/068,668

(22) Filed: Feb. 28, 2005

(51) Int. Cl. G06F 19/00

(52) U.S. Cl. 705/3; 128/898

(57) ABSTRACT

A method for clinical calculation of anesthetic administration is disclosed. The method includes the step of providing a source containing anesthetic administration calculation programming. A a user device adapted and constructed to receive data from the source is also provided. Anesthetic administration data from the source is loaded onto the user device. Specific patient data is input into the user device. Anesthetic information for the specific patient on the user is then displayed.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The invention relates generally to administration of anesthesia, specifically to calculating the administration of anesthesia with speed, ease, and accuracy.

### DESCRIPTION OF RELATED ART

The term “anaesthesia” was coined by the physician and poet Oliver Wendell Holmes in 1846, from the Greek word meaning ‘lack of sensation’. Long before that, anesthesia had been known, in various forms and by other names, since prehistory. The ancient Incas chewed coca leaves to numb the senses during ritual “surgery”, and the Chinese used opium and acupuncture to similar ends. The Mandragora root was used in Medieval and Elizabethan times to induce sleep and reduce pain associated with medical procedures. It was common in the 17^{th} century to give a patient several drinks of alcohol before medical procedures. It is not surprising that, before the discovery of modern anesthesia, the most valued characteristic of a skilled surgeon was speed.

Today, the term “anesthesia” refers to the administration of a medicine or medicines, “anesthetic”, to make a patient comfortable during a medical procedure, typically a surgical procedure. Anesthetic can be administered in many forms. In gaseous form, anesthetic may be transmitted to a patient through a face mask. Liquid anesthetic can be delivered through intubation of the patient's nose or throat, or by injection.

Anesthesia affects the nervous system by depressing or numbing nerve pathways. General anesthesia affects the patient's brain cells, causing loss of consciousness. Regional anesthesia effects nerve bundles in a specific area of the patient's body, resulting in a loss of sensation in a targeted region without loss of consciousness.

Prof. Dr. Theodor Billroth, considered to be the father of modern abdominal surgery, once asked, “Is there a greater example of Man's trust in Man than in which one allows himself to be placed by others in a painless, unconscious and helpless condition through the inhalation of a stupefying poison?”. Dr. Billroth's point remains well-taken to this day. Anesthetic agents are toxic in sufficient dosages, and the line between toxicity and efficacy can be relatively thin. The modern anesthesiologist must choose the types and amounts of anesthetic agents to maintain a sufficient anesthetic effect without harming the patient. This requires performing calculations prior to administering anesthesia, taking into account the type of anesthetic and the characteristics (e.g. age, size, and health) of the patient. The patient must then be closely monitored during and after administration of anesthetic.

A variety of techniques and apparatus have been developed to assist in anesthesia administration. One example can be seen in U.S. Pat. No. 5,522,387 to Simons is directed to a method to assess anesthesia in which a patient's general state of anesthesia is displayed as a Cartesian plot of two vital signs: heart rate and blood pressure, in a window on a monitor. The heart rate is plotted on the x-axis while blood pressure is plotted on the y-axis. An anesthetist selects minimum and maximum values for each vital sign which are appropriate for the patient. These limits denote a desired zone which is indicated on the display. As the heart rate and the blood pressure are monitored, the general state is shown as an indicator on the plot as a multi-variable function of the two vital signs. When the indicator is within the desired zone, the two vital signs are in an acceptable range. When the indicator is outside of the desired zone, a visual or audible alarm indicates potential patient distress.

In another example, U.S. Pat. No. 5,718,223 to Protas deals with an anesthesia delivery system with a method for efficiently recording and entering multiple anesthetic treatment variables, including all the data conventionally recorded in an anesthetic record, as well as anesthesia outcome data, into an integrated computer data base. The data base is thereafter subjected to trend analysis to identify any statistically significant nexus between treatment variables with sub-optimal outcomes. Accurate cost trend information is also provided. In preferred embodiments of the present invention, the required use of standardized practice protocols are disclosed in a method that optimizes the identification of any such nexus. Thus, the disclosed method provides accurate information useful for the modification and improvement of delivered anesthetic care.

In another example, U.S. Pat. No. 6,605,072 to Struys shows a system and method for controlling the administration of medication to a patient utilizes adaptive feedback to achieve and maintain a target effect in said patient. A sensor package having one or more sensors is used to sense an attribute of the patient and to provide a parameter indicating the attribute being sensed. A medication delivery controller accepts one or more parameters from the sensor package and uses these parameters to determine the effect of a medication on a patient and the concentration level of medication that will achieve a desired effect. The medication delivery controller controls the medication delivery unit to deliver the medication at a rate determined to achieve said target concentration level of said medication in said patient. If the patient's response to a given medication changes as a result of external stimuli, the medication delivery controller can detect this change and determine a new concentration level of medication which will achieve the desired effect. The medication delivery controller can steer the medication delivery unit to administer an amount of medication to reach this new concentration level.

U.S. Pat. No. 6,658,396 to Tang involves neural network drug dosage estimation. Neural networks are constructed (programmed), trained on historical data, and used to predict any of (1) optimal patient dosage of a single drug, (2) optimal patient dosage of one drug in respect of the patient's concurrent usage of another drug, (3a) optimal patient drug dosage in respect of diverse patient characteristics, (3b) sensitivity of recommended patient drug dosage to the patient characteristics, (4a) expected outcome versus patient drug dosage, (4b) sensitivity of the expected outcome to variant drug dosage(s), (5) expected outcome(s) from drug dosage(s) other than the projected optimal dosage. Both human and economic costs of both optimal and sub-optimal drug therapies may be extrapolated from the exercise of various optimized and trained neural networks. Heretofore little recognized sensitivities—such as, for example, patient race in the administration of psychotropic drugs—are made manifest. Individual prescribing physicians employing deviant patterns of drug therapy may be recognized. Although not intended to prescribe drugs, nor even to set prescription drug dosage, the neural networks are very sophisticated and authoritative “helps” to physicians, and to physician reviewers, in answering “what if” questions.

While know systems provide mechanisms for feedback and monitoring of patients under anesthetic, they fail to adequately address the need for determining dosages prior to anesthetic administration. It can be seen from the foregoing that the need exists for a system to easily, quickly, and accurately calculate anesthesia values that overcomes the shortfalls of known arrangements in this technology.

### SUMMARY

In accordance with the principles of the present invention, a method for clinical calculation of anesthetic administration is disclosed. The method includes the step of providing a source containing anesthetic administration calculation programming. A a user device adapted and constructed to receive data from the source is also provided. Anesthetic administration data from the source is loaded onto the user device. Specific patient data is input into the user device. Anesthetic information for the specific patient on the user is then displayed.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a schematic view of a system incorporating the principles of the present invention.

FIG. 2 illustrates a high-level functional schematic diagram of a clinical calculator incorporating the principles of the present invention.

FIG. 3 illustrates a high-level functional schematic diagram of an embodiment of a clinical calculator incorporating the principles of the present invention.

FIG. 3A illustrates specific output based on data entered in the embodiment of FIG. 3.

FIG. 3B illustrates specific output based on data entered in the embodiment of FIG. 3.

FIG. 3C illustrates specific output based on data entered in the embodiment of FIG. 3.

FIG. 3D illustrates specific output based on data entered in the embodiment of FIG. 3.

FIG. 3E illustrates specific output based on data entered in the embodiment of FIG. 3.

FIG. 3F illustrates specific output based on data entered in the embodiment of FIG. 3.

FIG. 3G illustrates specific output based on data entered in the embodiment of FIG. 3.

FIG. 3H illustrates specific output based on data entered in the embodiment of FIG. 3.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

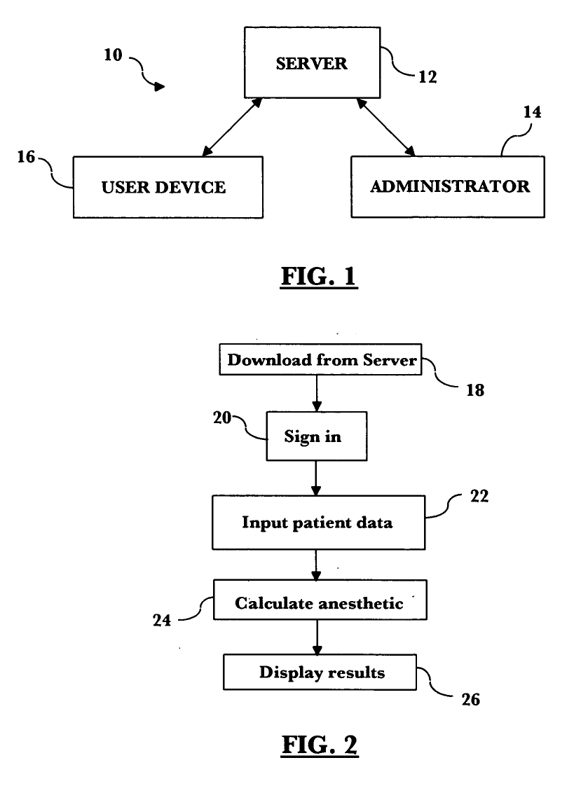

FIG. 1. Illustrates a schematic diagram of the principal components of an anesthesia clinical calculator 10 in accordance with the principles of the present invention. The calculator 10 can be used as a learning tool by anesthesia practitioners, such as residents, students, or instructors, to greatly simplify the calculations required for the administration of anesthetic. A server 12 contains the structure and function of the calculator 10, and can be provided as a server accessible via the internet, LAN, or other network. The structure and function are determined by an administrator 14, who can access the server either directly or via a remote connection. It is contemplated that the administrator will determine clinical parameters of the system, as well as management factors such as periodically required updates, registration of users, and the like. The administrator could also provide data to the providers of anesthetic medicaments and apparatus to improve their knowledge of, for example, product usage and outcomes. A user device 16 is employed by the end-user, and can be provided as a programmable computing device capable of data storage, manipulation, and display. Such devices include, but are not limited to, personal computers, laptops, and hand-held devices such a PALMs and pocket PC's.

FIG. 2. Illustrates the basic functioning of a system in accordance with FIG. 1. First, at 18, the user downloads the calculator data from the server. The download protocol can include requiring identifying information from the user, such as name and location, status of the practitioner (student, intern, resident, instructor), years in practice, or any other pertinent data. At this time, any user data previously entered or calculated with the user device 16 can be uploaded into the server. This will allow the administrator to view and employ actual user data for any suitable purpose. For example, user data can be compiled to create a database of user information to provide an additional source of output, giving users real-world information to assist in using calculation outputs. The user will then be provided with a system appropriate to the intended use. With the calculator downloaded, the user is required to sign in with each use at 20. This will not only identify the user, but will permit the calculator to determine if the user has all of the necessary updates. Prompts, reminders, and the like can be displayed at this step. Next, the user inputs patient data for the present calculation at 22. The parameters for such data can be customized to any desired situation, as will be described in detail herein. With the patient data entered, calculations are performed at 24, and displayed at 26.

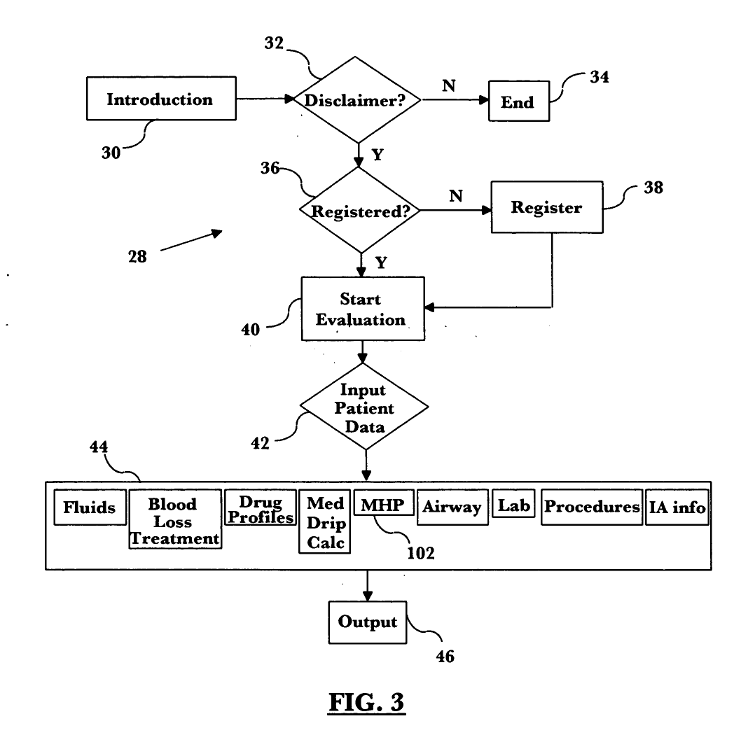

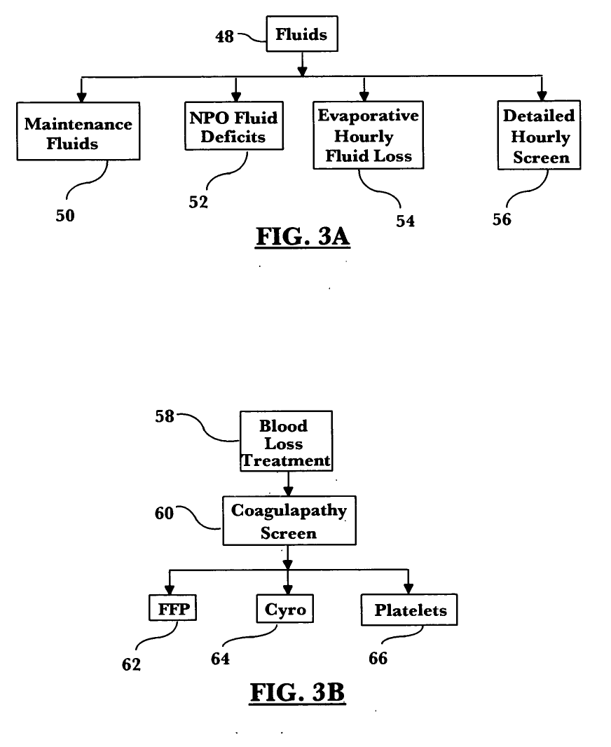

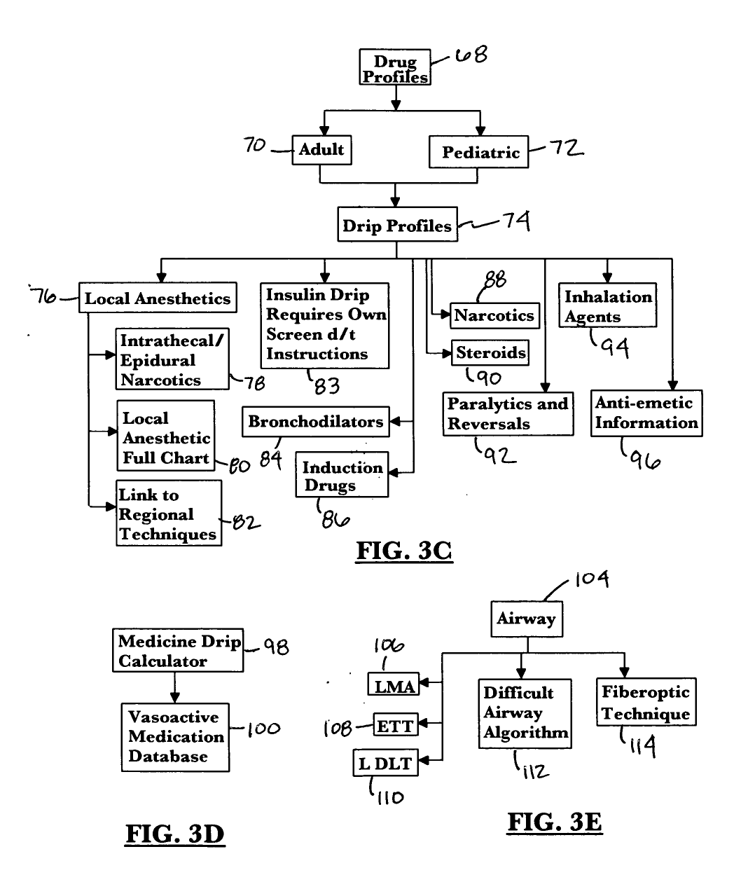

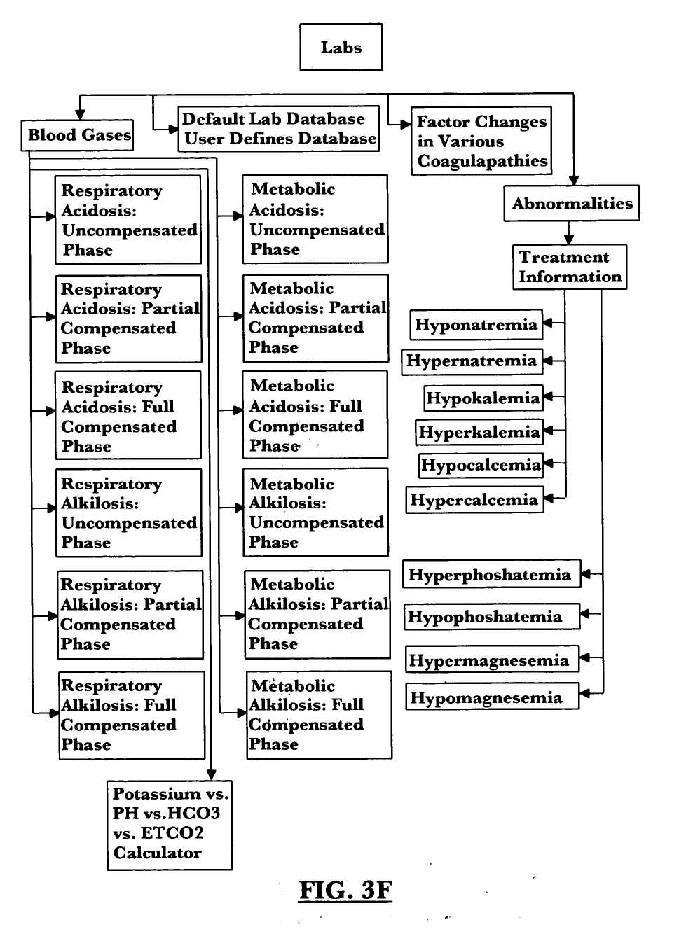

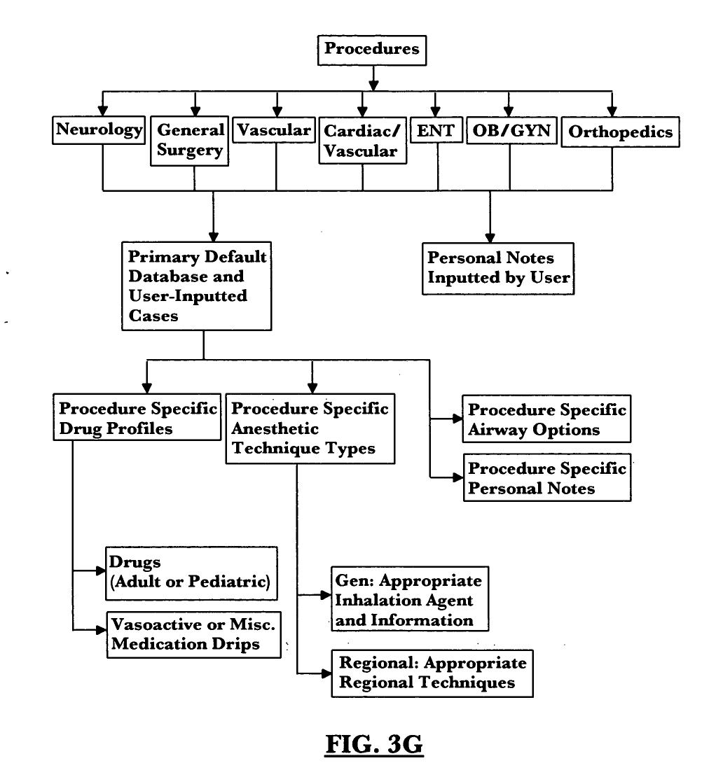

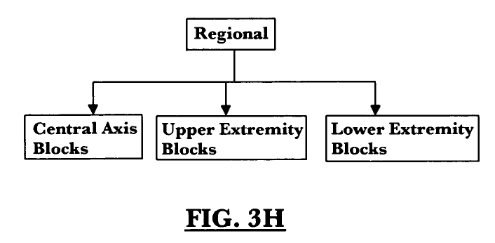

FIG. 3. illustrates an example of how the system can function at the user end. An introduction screen appears at 30, and can include titles, copyright notices, and other desired information. Proceeding to 32, a disclaimer screen is shown, which can incorporate an end-user agreement. If the user does not agree, the program ends at 34. If the user agrees, he is then prompted for registration information at 36. If the user is not registered, the registration procedure begins at 38, which may require connection to the server. If the user is registered, he enters the registration data, and proceeds to the start evaluation at 40. At this point, information such as the basic type of anesthesia parameters can be entered, leading to the prompting for entry of patient data at point 42. At 44, the patient data entered is used to calculate the required factors affecting the particular patient situation, which can be customized as mentioned before. Once the calculations are complete, the output is displayed at 46.

The specific outputs of the calculations will depend upon the parameters relevant to each patient situation. Some examples of parameters and outputs are shown in FIGS. 3a through 3H. In FIG. 3A, the fluid data 48 can include maintenance fluids 50, NPO fluid deficits 52, evaporative hourly fluid loss 54, and detailed hourly fluid screening 56. FIG. 3B shows blood loss treatment data 58, which can include coagulapathy 60, FFP 62, Cyro 64, and platelets 66. Drug profiles 68 are described in FIG. 3C, and can differ based on whether the patient is and adult 70 or pediatric patient 72. Drip profiles 74 can then be calculated. If a local anesthetic is indicated, the output can include intrathecal or epidural narcotics at 78, a local anesthetic full chart 80, and/or a link to regional techniques at 82. Insulin drip data is displayed at 83. Brochodilators are shown at 84, with specific induction drugs at 86. Narcotics are shown at 88, and steroids at 90. Paralytics and reversals are at 92, inhalation agents at 94, and anti-ematic information at 96. It is contemplated that any other drug profile information can be provided as desired. Medication drip calculation 98 is shown in FIG. 3D, and can include a vasoactice medication database 100. If indicated, malignant hypothermia protocols 102 can also be displayed. In FIG. 3F, airway factors 104 are shown. These can include LMA 106, ETT 108, I DLT 110, difficult airway algorithms 112, and fiberoptic techniques 114. Lab factors are shown in FIG. 3F, procedural schematics in FIG. 3G, and regional considerations in FIG. 3H.

While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. A method for clinical calculation of anesthetic administration, the method comprising the following steps:
providing a source containing anesthetic administration calculation programming;
providing a user device adapted and constructed to receive data from the source;
loading anesthetic administration data from the source onto the user device;
inputting specific patient data into the user device; and
displaying anesthetic information for the specific patient on the user. device.

2. A method in accordance with claim 1, wherein the step of providing a source comprises providing a server.

3. A method in accordance with claim 1, wherein the step of providing a source comprises providing an internet server.

4. A method in accordance with claim 1, wherein the step of providing a source comprises providing a LAN server.

5. A method in accordance with claim 1, wherein the step of providing a user device comprises providing a PC.

6. A method in accordance with claim 5, wherein the step of providing a user device comprises providing a hand-held computing device.

7. A method in accordance with claim 1, further comprising the step of uploading information from the user device to the source.
